(19) United States
(12) Patent Application Publication
(10) Pub. No.: US 2026/0100038 A1
(43) Pub. Date: Apr. 9, 2026

(54) SENSITIVE CONTENT DETECTION ON ONLINE LEARNING PLATFORMS USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Pedro Ricardo Gomes Dias, Hong Kong (CN); Zoltan Szalontai, Kecskemet (HU); Ishan Tripathi, Noida (IN); Gaurav Shukla, Calgary (CA)

(73) Assignee: 2hr Learning, Inc., Austin, TX (US)

(21) Appl. No.: 19/352,353

(22) Filed: Oct. 7, 2025

Related U.S. Application Data
(60) Provisional application No. 63/704,530, filed on Oct. 7, 2024.

(51) Int. Cl. G06V 20/40; G06V 10/776; G06V 10/82

(52) U.S. Cl. CPC G06V 20/41; G06V 10/776; G06V 10/82; G06V 20/46

(57) ABSTRACT

A sensitive content detection system and method to enhance the accuracy and reliability of sensitive content detection by analyzing videos using multiple AI engines is disclosed. The sensitive content detection method receives video data from a cloud database, where all recorded videos are stored. A video extractor extracts video frames at pre-defined intervals, each representing a video segment for analysis. A batch of frames is sent to a primary AI engine utilizing machine learning algorithms to detect sensitive content. If sensitive content is found, the corresponding frames are marked positive and sent to secondary AI engines, each specialized in detecting specific types of sensitive content. The results from the primary and secondary AI engines are then aggregated using a consensus mechanism, with the final result based on a predefined agreement threshold.

### CROSS-REFERENCE TO RELATED APPLICATION(S)

This application claims the benefit under 35 U.S.C. § 119 (c) and 37 C.F.R. § 1.78 of U.S. Provisional Application No. 63/704,530, which is incorporated by reference in its entirety.

### FIELD OF THE INVENTION

The present invention relates in general to the field of electronics, specifically a system, and method for enhancing the accuracy and reliability of detecting sensitive content by analyzing video in online learning platforms that utilize a plurality of Artificial Intelligence tools.

### BACKGROUND OF THE INVENTION

In today's environment, the risk of sharing sensitive information through online content is very high, and it's quite hard to prevent the sharing of sensitive information in online video content. The display of sensitive credentials is particularly problematic during video sessions associated with online learning, corporate meetings, health consultations, legal proceedings, banking and financial services, and customer care and support services. These environments typically involve processing large volumes of video data where accuracy, efficiency, and privacy are paramount.

Traditional methods include manual verification, single Artificial Intelligence (AI) systems, and hybrid systems often suffer from inaccuracy, delays, and increased costs. Manual verification requires significant human effort and time, which is not scalable for large volumes of video content. Human verification is subject to bias and inconsistent standards. Hybrid systems require effective integration and communication between AI outputs and human verifiers, which results in rigidity and complexity and incurs higher costs and time than fully automated systems.

Traditional video analysis systems for detecting sensitive content typically employ one AI system, which might be trained on a generalized dataset. While effective to a degree, these systems struggled with content that deviated from their training data. Single Artificial Intelligence systems cannot effectively handle the diverse complexities and nuances present in different video contexts, resulting in privacy breaches or unnecessary censorship.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary sensitive content detection system for enhancing the accuracy and reliability of the content during the online learning session in an online learning platform.

FIG. 2 depicts an exemplary sensitive content detection process for enhancing the accuracy and reliability of the content during the online learning session in an online learning platform.

FIG. 3 depicts an exemplary sensitive content finalization process, which is an embodiment of the sensitive content detection process for enhancing the accuracy and reliability of the content during the online learning session in an online learning platform of FIG. 2.

FIG. 4 depicts an exemplary video analysis process, which is an embodiment of the sensitive content detection process for enhancing the accuracy and reliability of the content during the online learning session in an online learning platform of FIG. 2.

FIG. 5 depicts an exemplary data structure 500 for organizing data to detect sensitive content during an online learning session.

FIG. 6 depicts an exemplary user interface disclosing a blurred screen as a result of sensitive content (nudity) being detected in the webcam feed during the stored recording.

FIG. 7 depicts an exemplary user interface disclosing a blurred screen as a result of sensitive content (credit card details) in the screen recording feed in the stored recording.

FIG. 8 depicts an exemplary network environment in which the sensitive content detection system of FIG. 1 and the sensitive content detection process of FIG. 2 may be practiced.

FIG. 9 depicts an exemplary computer system.

### DETAILED DESCRIPTION

The sensitive content detection system and method set forth herein address technical issues with generating the content during the online learning session in an online learning platform described herein. Conventionally, manual processes were used to generate the content during the online learning session in the online learning platform and were very tedious and time consuming. The present sensitive content detection system and method utilize an automated system that does not merely automate a manual process or use a conventional system in a conventional way. The present sensitive content detection system and method utilize one or more artificial intelligence (AI) engines and integrate programmatic process management to technologically guide and constrain the one or more AI engines to produce the content during the online learning session in the online learning platform in a completely different way than both any manual process and different than normal use of programs and AI engines. Utilizing specially engineered guidance and control to direct an AI system in solving the technical problems presented below, which require a technical solution. The sensitive content detection system and method described below are not simply engaging a computer to carry out conventional mental processes, but rather change how computers (and AI systems, specifically) operate to achieve the generation results that were not previously possible or were substantially inefficient prior to the sensitive content detection system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the sensitive content detection system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The sensitive content detection system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce accurate and reliable content during the online learning session, perform quality control to retain or automatically discard outputs that do not meet guidance and constraints, and make the desired outputs available for use, such as use by computer system applications. In at least one embodiment, the problem to be solved by the integrated programmatic and AI engine sensitive content detection system and method is uniquely and unconventionally decomposed, and AI prompts are used to solve the decomposed problem. Furthermore, the programmatic inputs to the decomposed AI prompts provide guidance to enhance the accuracy and reliability of the content during the online learning session in the online learning platform

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the sensitive content detection system and method described herein. Thus, the present sensitive content detection system and method described implement an integration of programmatic management over decomposed prompts with engineered AI engine guidance and constraints to affect an improvement in AI, programmatic AI management, and AI integrated with programmatic management technology. The present sensitive content detection system and method allow computer systems to include programmatic management, one or more AI engines, and one or more data sources to produce accurate and reliable content during the online learning session in the online learning platform that previously could not be produced with conventionally prompted AI engines or could only be produced by humans utilizing a completely different, time consuming, and tedious process. The sensitive content detection system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the sensitive content detection systems and methods. For example, use of the term “invention” does not limit or require the referenced certain features to be present in all embodiments of the invention. Use of absolute-type terms, such as “required,” “must,” “only,” “important,” and so on are not limiting of all embodiments of the sensitive content detection systems and methods and not to be construed as limiting of the embodiments of the sensitive content detection systems and methods described above.

A sensitive content detection system for enhancing the accuracy and reliability of the content during the online learning session in an online learning platform is disclosed. The sensitive content detection system for enhancing the accuracy and reliability of sensitive content detection includes the online learning platform that is operatively coupled to a video analysis module. A receiver is integrated into the video analysis module and is configured to collect input data from a cloud database, which stores the video of the online learning sessions. The collected input data is then provided to a video extractor, which is configured to extract video frames from the video in predefined intervals. These video frames, along with prompts generated by a prompt engineer, are provided to the primary AI engine. The prompts provided to the primary AI engine include rules and guidelines to provide the output response.

Upon receiving the prompts and insights, the primary AI engine, the sensitive content in the video is detected. A sensitive content marker marks the video frame and its corresponding frame when a positive sensitive content is detected in any one of the video frames and sends the marked video frames to a secondary AI engine. The secondary AI engine is configured to cross-verify positive sensitive content detections made by the primary AI engine. An aggregator that utilizes a consensus mechanism aggregates the results from the primary and secondary AI engines.

Further, the positive marked sensitive content is passed to a quality checker which is configured to check the quality of the positive marked sensitive content for quality verification and modifies the content in these frames by blurring and overlaying the positive marked video frames received from the aggregator. The final result is presented to the user through a display module along with a confidence score on a user interface integrated within the online learning platform.

The sensitive content detection system for enhancing the accuracy and reliability of sensitive content detection in video analysis in online platforms ensures that the detection of sensitive content such as nudity or payment-related information is accurate, reducing false positives and negatives significantly. The sensitive content detection system is particularly beneficial in educational and professional settings where high accuracy in sensitive content detection is crucial, which ensures content moderation is both precise and reliable, safeguarding user privacy and compliance with content standards.

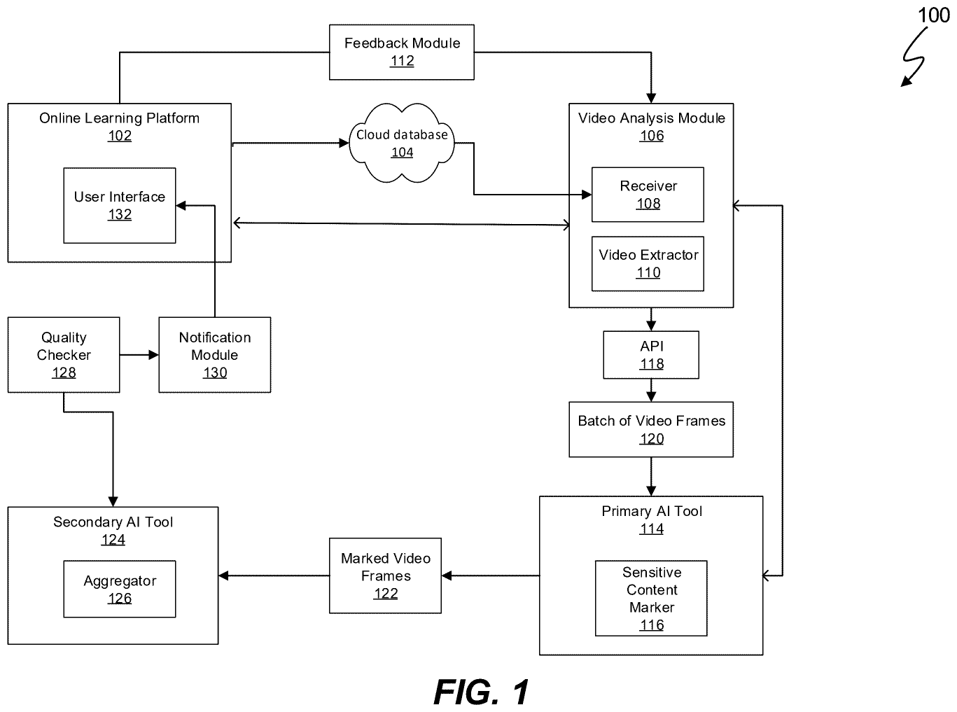

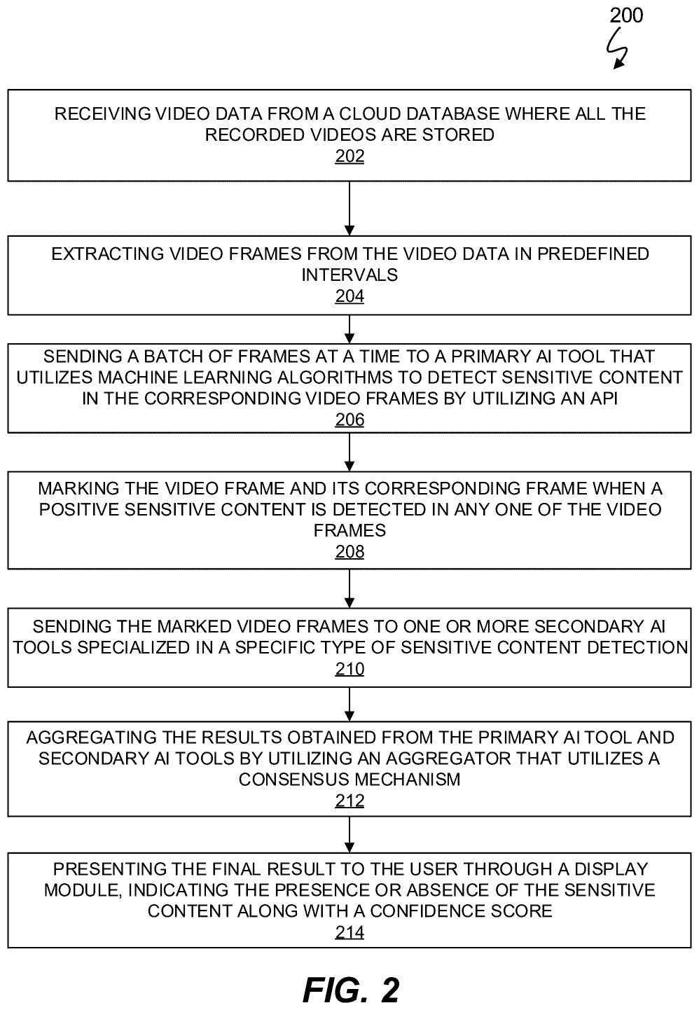

FIG. 1 depicts an exemplary sensitive content detection system 100 for enhancing the accuracy and reliability of the content during the online learning session in an online learning platform 102. FIG. 2 depicts an exemplary sensitive content detection process 200 for enhancing the accuracy and reliability of the content during the online learning session in an online learning platform 102 utilized by the sensitive content detection system 100.

In operation 202, a receiver 110 collects the video from a cloud database 106. All the videos of the user undergoing an online learning session on the online learning platform 102 are stored in the cloud database 106.

The receiver 110 is integrated into a video analysis module 108, operatively coupled to the online learning platform 102. When the user accesses the online learning platform 102, the video of the whole online learning session gets recorded and stored in the cloud database 106, operatively coupled to the online learning platform 102 and the video analysis module 108. The cloud database 106 used in the sensitive content detection system 100 is AWS S3, although the storage database is not only limited to AWS S3, other tools can also be used, like Google Cloud Storage, Azure Blob Storage, and so on.

In operation 204, a video extractor 112 extracts the video frames from the received video data in pre-defined intervals. Each video frame represents a segment of the video for analysis.

The video extractor 112 is integrated within the video analysis module 108, which is operatively coupled to the online learning platform 102. This integration allows for seamless communication between the video extractor 112 and other components, particularly with the receiver 110, which supplies the video data.

The video extractor 112 breaks down the received video data into individual frames for detailed analysis. Upon receiving the video data from the receiver 110, which is responsible for fetching or collecting the video from the cloud database 106, the video extractor 112 operates by dividing the continuous stream of video into smaller, manageable units or chunks, referred to as video frames. These frames are captured at pre-defined intervals, i.e., the video extractor 112 extracts specific frames at regular time intervals throughout the video, ensuring a representative set of frames from various segments of the video is available for analysis.

Each extracted frame serves as a snapshot of a particular moment in the video and represents a segment of the video content. By converting the video into a series of individual frames, the video analysis module 108 can perform a more focused analysis, ensuring that sensitive content, such as inappropriate visuals or sensitive information, can be detected frame by frame.

In operation 206, the video extractor 112 sends a batch of video frames 116 at a time to a primary AI engine 118 that utilizes machine learning algorithms to detect sensitive content in the corresponding video frames by utilizing an API 114.

The video extractor 106 is responsible for converting the video into video frames and transferring them in batches to a primary AI engine 118 for further processing. Rather than sending individual frames one by one, the extractor groups frames into batches 116, which enhances efficiency by allowing the primary AI engine 118 to process multiple frames simultaneously. These batches 116 are transmitted through an API 114, which serves as the communication interface between the video extractor 112 and the primary AI engine 118. For instance, for nudity detection one video frame is shared with the primary AI engine 118 every two seconds, and in the case of payment-related sensitive information, one video frame is shared with the primary AI engine 118 every 5 seconds.

Along with each batch of video frames 116, prompts are also provided to the primary AI engine 118. These prompts contain contextual information about the type of sensitive content the primary AI engine 118 is expected to detect, helping to guide its analysis. The prompt further includes rules, guidelines, examples, and output format. This helps to guide the primary AI engine to generate the result in the way the user needs. For instance, the prompts could indicate whether the content is from a webcam recording, which would prioritize nudity detection, or from a screen recording, which would focus on detecting sensitive financial information, such as credit card or debit card details.

The primary AI engine 118 utilizes advanced machine learning algorithms, specifically convolutional neural networks (CNNs), that analyze the video frames 116. CNNs are particularly well-suited for image and video analysis, as they can detect patterns, shapes, and specific features within the frames. This capability makes CNNs highly effective in detecting various types of sensitive content, including nudity and payment-related data, such as credit card details, which could appear in screen recordings.

The primary AI engine 118 can differentiate between types of sensitive content guided by the nature of the video source. For example, nudity-related sensitive content is generally identified from webcam recordings, where personal or inappropriate images might be more prevalent. On the other hand, payment-related sensitive content, such as credit card or debit card details, is typically found in screen recordings, where a user may be entering or displaying sensitive financial information.

An exemplary prompt provided to the primary AI engine 118, to detect the presence of nudity is given below:
“
Your job is to accurately detect the following features in student webcam recordings: {list_of_features}. Some things might be hard to discern, but should not be flagged, such as explicit paintings or skin-colored clothing that might be mistaken for bare skin. We are not rooting for any outcome; precision is all that matters. Be accurate and triple-check your answers. Respond with a JSON object containing a verdict (true or false) for each feature and a summarized reason explaining the detection. Output only the JSON. Here are two examples of the expected output:
Example 1: {“exposed chest”: true, “upper body nudity”: true, “visible nipples”: true, “exposed breasts”: true, “buttocks”: false, “genitalia”: false, “reason”: “Nudity detected”}
Example 2: {“exposed chest”: false, “upper body nudity”: false, “visible nipples”: false, “exposed breasts”: false, “buttocks”: true, “genitalia”: false, “reason”: “Nudity detected”}
”

The prompt designed by a prompt engineer is provided to the primary AI engine 118 to identify whether the video frame contains any nudity content or not. The prompt guides the primary AI engine 118 to detect specific features that are marked as sensitive. The prompt aims for precision and consistency in detection. The complete list_of_features that are marked as sensitive is as follows: ‘exposed chest’, ‘upper body nudity’, ‘visible nipples’, ‘exposed breasts’, ‘buttocks’, and ‘genitalia.’ The prompt can be revised to identify other specific or general anatomic features or relevant references. The prompt does not mandate the presence of all the features listed simultaneously to make the received video positive for the presence of sensitive content. The presence of any of the listed features in the received video makes it positive for the presence of sensitive content. For example, the presence of exposed chest or upper body nudity is considered as the presence of nudity even if the other listed features like buttocks and genitalia are absent in the video.

The primary AI engine 118 is asked to provide the output in JSON format, containing a single key and the summarized reason explaining the detection, i.e., the presence of each sensitive feature as either ‘true’ or ‘false’ and the summarized reason as ‘Nudity detected’ or ‘Nudity not detected’. The main objective of the prompt is to determine the presence or absence of nudity in the video. For instance, ‘true’ is indicated for the presence of a particular sensitive feature in the video, and ‘false’ is indicated for the absence of a particular sensitive feature in the video.

In operation 208, a sensitive content marker 120 marks the video frame and its corresponding frame when a positive sensitive content is detected in any one of the video frames.

The sensitive content marker 120 is integrated within the primary AI engine 118 and is configured to mark the particular part of the video frame as positive where the sensitive content is detected. For instance, if a video contains sensitive content, say a credit card is shown during the online learning session for a period of 5:05-6:00. Then, the sensitive content marker 120 will mark the video frame of this duration as positive.

In operation 210, the sensitive content marker 120 sends the marked video frames 122 to one or more secondary AI engines 124. Each secondary AI engine 124 is specialized in a specific type of sensitive content detection.

The sensitive content marker 120 marks video frames that have been identified by the primary AI engine 118 as containing potentially sensitive content. Once the primary AI engine 118 detects sensitive content in a batch of video frames 116, it forwards the relevant frames to the sensitive content marker 120. The marked video frames 122, which include sensitive content such as nudity or payment-related information, are then sent to one or more secondary AI engines 124 for further analysis.

Each secondary AI engine 124 is highly specialized in detecting a specific type of sensitive content. For example, one secondary AI engine might focus on detecting nudity, while another secondary AI engine might specialize in identifying payment-related information, such as credit or debit card details. By utilizing specialized secondary AI engines 124 for each type of sensitive content detection, it is ensured that the detection of the sensitive content is not only thorough but also highly accurate. These specialized AI engines act as experts in their respective fields, capable of verifying whether the initial detection made by the primary AI engine 118 is correct or not.

In addition to the marked frames, prompts are provided to the secondary AI engines 124, which are written by a prompt engineer. These prompts include context that guides the secondary AI engines 118 on what specific type of content they are expected to verify. For instance, a prompt might indicate that the frame contains potential nudity or payment-related data, and this helps the secondary AI engines 124 to fine-tune their verification step. Along with this the prompt also includes rules, guidelines, examples, and output in which the user wants the response to be generated.

The secondary AI engines 124 are specifically configured to cross-verify the positive sensitive content detections made by the primary AI engine 118. This means that the secondary AI engines 124 reassess the positively marked video frames to ensure the initial findings were accurate. For example, if the primary AI engine 118 detected nudity in a webcam recording, the secondary AI engine 124 specializing in nudity detection would analyze the same frames to confirm whether the detected content is sensitive or not, as in some cases there may be a scenario where the primary AI engine 118 may detect a false positive sensitive content. By having this cross-verification, the risk of false positive detection is reduced ensuring that only truly sensitive content is marked.

An exemplary prompt provided to the secondary AI engine 124, which utilizes the machine learning algorithms to cross-verify positive sensitive content detections made by the primary AI engine 118 is given below:
“
You are an image analysis expert. Your task is to verify that the following statement is true for at least one of the provided images. If the statement describes a painting, respond with “false”. The statement is: “{reason}
”
Analyze the provided images and respond with a single word. If the statement is true for at least one image without any uncertainty, respond with “true”, otherwise “false”.
”

The prompt generated by the prompt engineer is provided to the secondary AI engine 124 to cross-verify the positive sensitive content detections made by the primary AI engine 118. The prompt verifies the reasoning provided by the initial analysis of the primary AI engine 118. The prompt ensures accuracy and reduces false positives and false negatives. The prompt guides the secondary AI engine 124 to verify the reasoning provided by the primary AI engine 118. The prompt asks the secondary AI engine 124 to analyze the provided images and respond with a single word. For example, if the statement describes a painting, respond with ‘false’.

The secondary AI engine 124 is asked to provide the output in JSON format, containing a single key that verifies the presence of positive sensitive content. i.e., the presence of the sensitive content as either ‘true’ or ‘false’. For instance, if the statement is true for at least one image without any uncertainty, respond with ‘true’ and if the statement is not true for at least one image, respond with ‘false’.

In operation 212, an aggregator 126 aggregates the results obtained from the primary AI engine 118 and secondary AI engine 124 by utilizing a consensus mechanism.

The aggregator 126 is integrated with the secondary AI engine 124 and aggregates the results from both the primary AI engine 118 and secondary AI engine 124. The aggregated result from the aggregator 126 is defined based on a predefined threshold agreement between the primary AI engine 118 and the secondary AI engine 124.

The consensus mechanism is used to ensure that the multiple AI engines agree on a single outcome or decision, and ensures consistency, reliability, and agreement even when different AI engines produce different results. Consensus mechanisms are critical for eliminating discrepancies, ensuring accurate decision-making, and avoiding false positives or false negatives, especially in cases where results are aggregated from multiple AI engines.

The consensus calculation for final verdicts is based on a 60% (⅔rd) agreement threshold. The presence of the sensitive content in the video frames is confirmed when the aggregated result from the aggregator 126 is equal to or greater than the predefined threshold. The absence of the sensitive content in the video is confirmed when the aggregated result from the aggregator 126 is less than the predefined threshold. For instance, when the aggregated result from the aggregator 126 is equal to or greater than 60% (⅔rd) agreement threshold, the presence of the sensitive content in the video is confirmed, and when the aggregated result from the aggregator 126 is less than 60% (⅔rd) agreement threshold, the absence of the sensitive content in the video is confirmed.

The aggregator 126 sends the aggregated results to a quality checker 128 configured to check the quality of the positive marked sensitive content for quality verification and modifies the content in these frames by blurring and overlaying the positive marked video frames. The quality checker 128, in case of the nudity-related sensitive content detection, blurs the content of the webcam, and in case of payment-related sensitive content detection, blurs the content of the browser.

The quality checker 128 is linked with a notification module 130 to inform the user's parents about any sensitive content detected during an online learning session, along with detailed information. The tool used for checking the quality of the result generated by the secondary AI engine 124 is Gemini Flash, although the quality check is not only limited to this tool, other tools like GPT-40, Claude-3.5-sonnet, and so on can also be used.

A feedback module 132 is configured to allow parents to provide feedback, including explanations about the video frames classified as sensitive content by the AI engines. For instance, if inappropriate content or nude content is detected by multiple AI engines. The notification module 130 provides notifications related to the same along with the video clip of that particular timeframe to the parents or guardians of the user, i.e., the student undergoing the online learning session. The parent can provide an explanation using the feedback module 132 to explain the reason why that particular incident happened, and so on.

In operation 214, user interface 104 presents the presence or absence of the sensitive content along with a confidence score. The confidence score represents the likelihood or probability that the sensitive content detected by the machine learning algorithm is correct.

The user interface 104 is integrated into the online learning platform 102 and is configured to present the final result to the user. The final result includes the presence or absence of sensitive content in the video, as well as the confidence score. This user interface 104 provides immediate feedback on the presence or absence of sensitive content during the online learning session.

The confidence score represents the likelihood or probability that the sensitive content detected by the machine learning algorithm is correct or not. This sensitive content could include nude content, payment-related information like credit card details, debit card details, and other pre-defined sensitive content types. By presenting this information, the online learning platform 102 ensures users are aware that no sensitive content is shared through the video on the online learning platform 102. Each time, the AI engines identify whether the video contains any sensitive information or not.

The pseudo-code used in the sensitive content detection system 100 is given below:

```
  function analyze_video(video):
  frames = extract_frames(video)
  results = [ ]
  for frame in frames:
  initial_result = primary_ai_service.analyze(frame)
  secondary_results = [ai_service.analyze(frame) for ai_service in
secondary_ai_services]
  final_result = apply_consensus([initial_result] +
secondary_results)
  results.append(final_result)
  return results
```

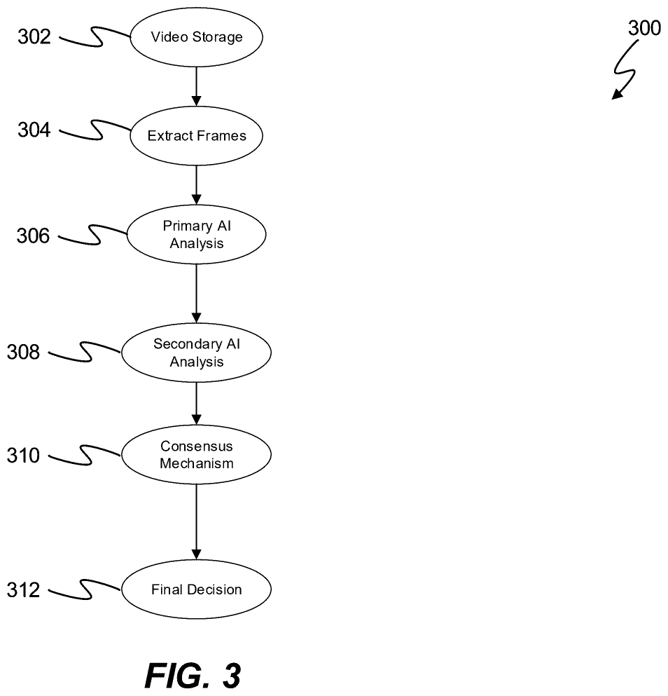

FIG. 3 depicts an exemplary sensitive content finalization process 300, which is an embodiment of the sensitive content detection process 200 for enhancing the accuracy and reliability of the content during the online learning session in an online learning platform 102 of FIG. 2.

The sensitive content finalization process 300 illustrates the detection of sensitive content in video content on online learning platforms 102. The sensitive content finalization process 300 starts when the user starts the online learning session and engages with the video content. The video footage of the online learning session gets recorded on the cloud database 106, representing the video storage 302. The receiver 110 is responsible for receiving the video from where the video storage 302, where all the videos are stored. The receiver 110 sends the received video to the video extractor 112.

The collected input data from the receiver 110 undergoes further processing in the form of video extraction. The video extractor 112 is responsible for extracting video frames 304 from the video data in predefined intervals. For instance, in the case of nudity-related content, one video frame is transferred per two seconds, and in the case of payment-related content, one video frame is transferred per five seconds. This data is predefined and can be changed on a case-to-case basis.

The video analysis module 106 calls the API (Application Programming Interface) 114 to transfer the extracted video frames in the form of video frame batches 116 to the primary AI engine 118, which utilizes multiple machine learning algorithms to detect the sensitive content in the batch of video frames 116 received from the video analysis module 108. Based on the detection of the sensitive content in the video frame, the sensitive content marker 120 marks the video and the corresponding frame. Once the primary AI analysis 306 is complete, the secondary AI engine 124 receives the marked frames 122 for the secondary AI analysis 308.

The aggregator 126, integrated with the secondary AI engine 124, aggregates the primary and secondary AI analysis results utilizing a consensus mechanism 310. The presence of sensitive content in the video is confirmed when the aggregated result from the aggregator 126 is equal to or greater than the pre-defined threshold. The absence of the sensitive content in the video is confirmed when the aggregated result from the aggregator 126 is less than the predefined threshold.

The quality checker 128 is configured to check the quality of the positive marked sensitive content for quality verification and makes a final decision 312. The quality checker 128 modifies the content in the video frames received from the aggregator 126 by blurring and overlaying the positive-marked video frames.

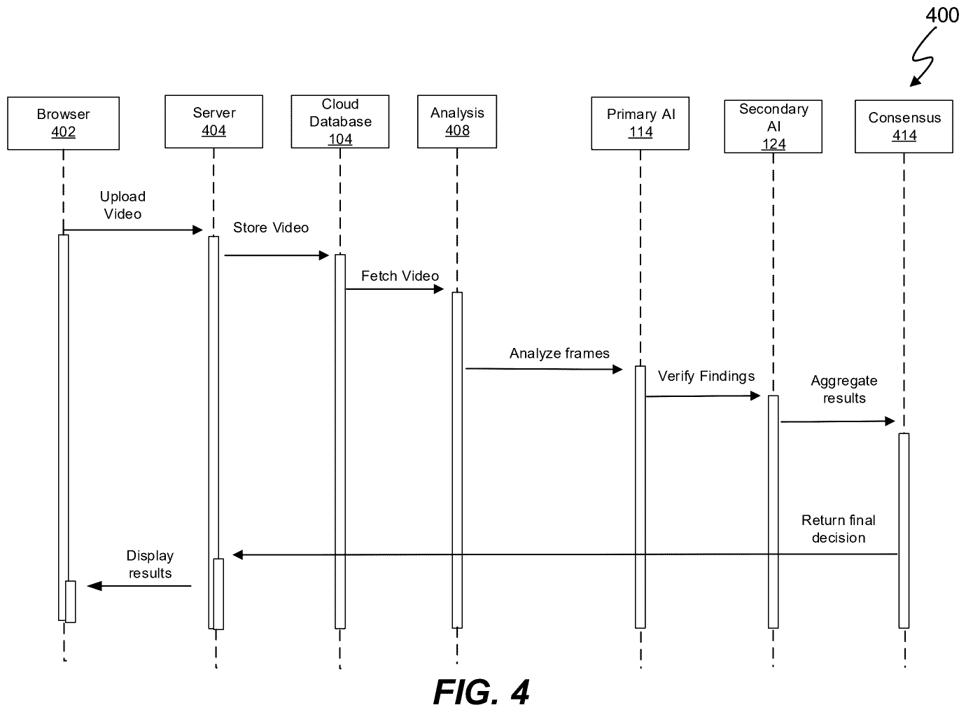

FIG. 4 depicts an exemplary video analysis process 400, which is an embodiment of the sensitive content detection process 200 for enhancing the accuracy and reliability of the content during the online learning session in an online learning platform 102 of FIG. 2.

The video analysis process 400 illustrates the detection of sensitive content by analyzing the video frames captured when the user is undergoing the online learning session in the online learning platform 102. The video analysis process 400 begins with the browser 402 of the online learning platform 102, where the user undergoes the online learning session and the video of the online learning session gets recorded on predefined framerate and timings. For instance, 1 video frame is sent every 2 seconds for detecting nudity. This action is sent to server 404, which receives the video data from the cloud database 106. The server 404 then stores the uploaded video in the cloud database 106, ensuring all recorded videos are centrally stored and easily accessible for processing.

Once stored in the cloud storage 106, the videos are retrieved by the video extractor 112. Here, the video is segmented into individual frames at predefined intervals, representing portions of the video that will undergo analysis 406. These frames are sent in batches to the primary AI engine 118, which utilizes machine learning algorithms to perform initial detection of sensitive content, such as nudity or payment-related information. If the primary AI engine 118 detects positive sensitive content in any frame, it marks that frame for further verification by using the sensitive content marker 120 (not shown in the figure).

The positive marked frames are then sent to one or more secondary AI engines 124, each of which specializes in verifying specific types of sensitive content, such as nudity or payment-related data. The secondary AI engine 124 cross-verify the findings of the primary AI engine 118, thereby enhancing the reliability of the detection. The results from the primary and secondary AI engines are then sent to a consensus mechanism 408, which aggregates and compares the findings from each AI engine. Based on a pre-defined threshold agreement, for instance, 60% or ⅔rd majority agreement between the AI engines, the consensus mechanism 408 determines the final decision regarding the presence or absence of sensitive content. If the threshold is met or exceeds the predefined values, the presence of sensitive content is confirmed, otherwise, it is classified as a false positive.

This final decision, along with a confidence score that represents the likelihood that the detected content is correct, is returned to server 404, which communicates the result back to the browser 402, where the user can view the final decision. If sensitive content is confirmed, blurring or overlaying the content is performed to modify the content before presenting it to the user or storing it on the cloud database 106.

The video analysis process 400 utilizes multiple AI engines, thereby improving both the accuracy and reliability of sensitive content detection by utilizing multiple layers of analysis, verification, and quality check.

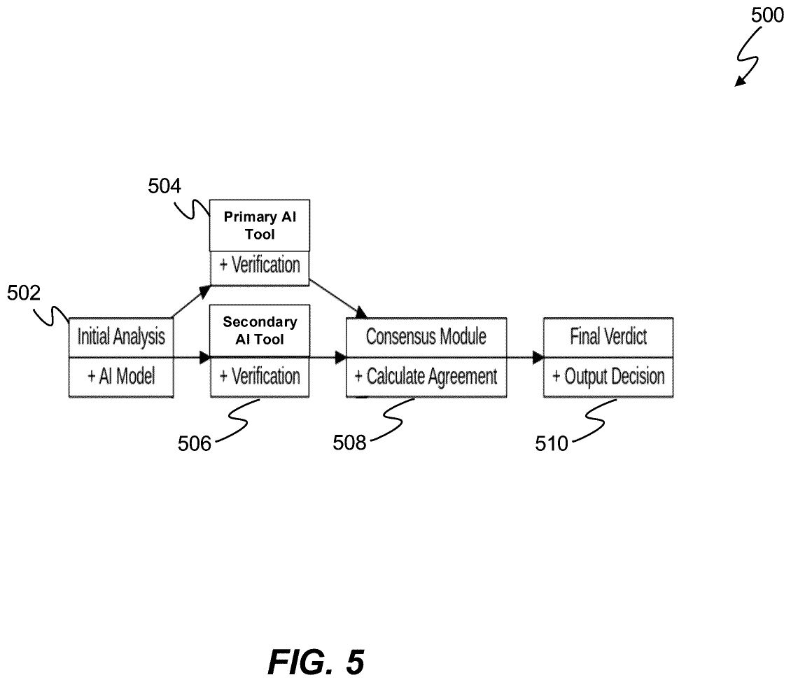

FIG. 5 depicts an exemplary data structure 500 for organizing data to detect sensitive content during an online learning session.

The data structure 500 illustrates the double-checking mechanism using multiple AI engines to enhance sensitive content detection through multiple verification stages and quality checks. The data structure 500 includes five important nodes, namely, Initial Analysis 502, Primary AI engine 118, Secondary AI engine 124, Consensus Module 504, and Final Verdict 506.

In the Initial Analysis 502 node, the video analysis module 108 (not shown in the figure) receives the video frames from the cloud database 106. After receiving the video frames, the video extractor 112 (not shown in the figure) extracts the video data at a predefined interval of time for analysis. The analyzed video frames are then passed on to the Primary AI engine 118 which performs the first check for the sensitive content on the video frames to detect potential sensitive content, such as nudity or payment-related information. The results from this initial Primary AI engine 118 are not final but rather sent to multiple Secondary AI engine 124 for verification.

Each of the AI engines, represented as Primary AI engine 118, and Secondary AI engine 124, independently re-analyzes the marked content for accuracy. These AI engines are designed to provide additional layers of verification, cross-checking the initial analysis and reducing the chances of false positives or false negatives. Once all the AI engines have completed their verification, the results are sent to a Consensus Module 504 node, which aggregates the outputs from each AI engine. The consensus mechanism 504 calculates the agreement between the services to determine whether the content is sensitive or not, based on a predefined threshold of agreement. If a majority of the services agree, the content is confirmed as sensitive.

Finally, the decision from the consensus module 504 is passed to the Final Verdict 506 node, where the output is determined. This final stage provides the user with a clear decision regarding the presence of sensitive content, ensuring that the verdict is accurate, reliable, and cross-verified by multiple AI engines.

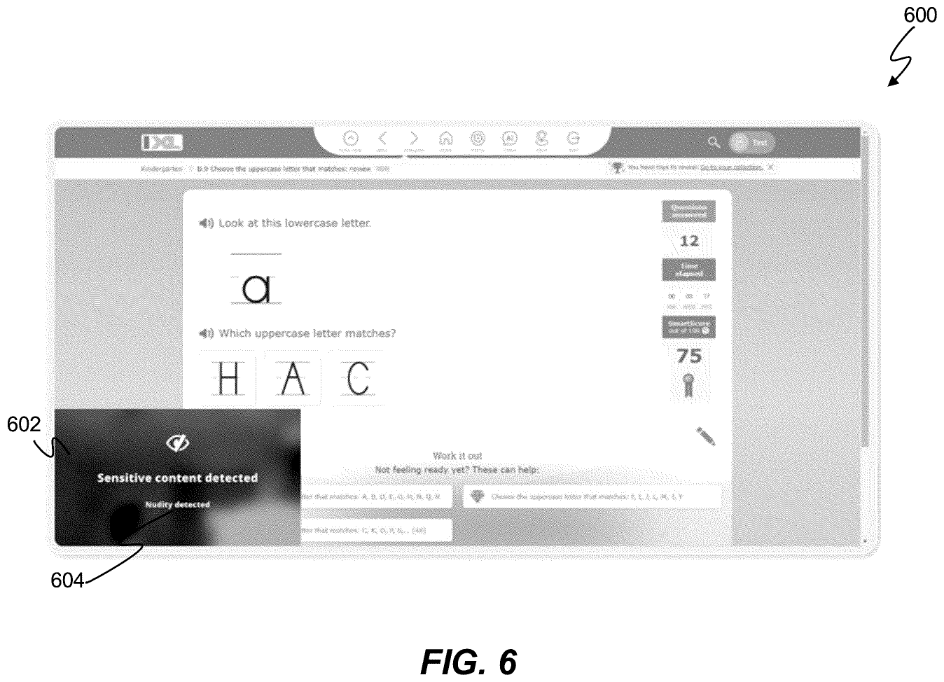

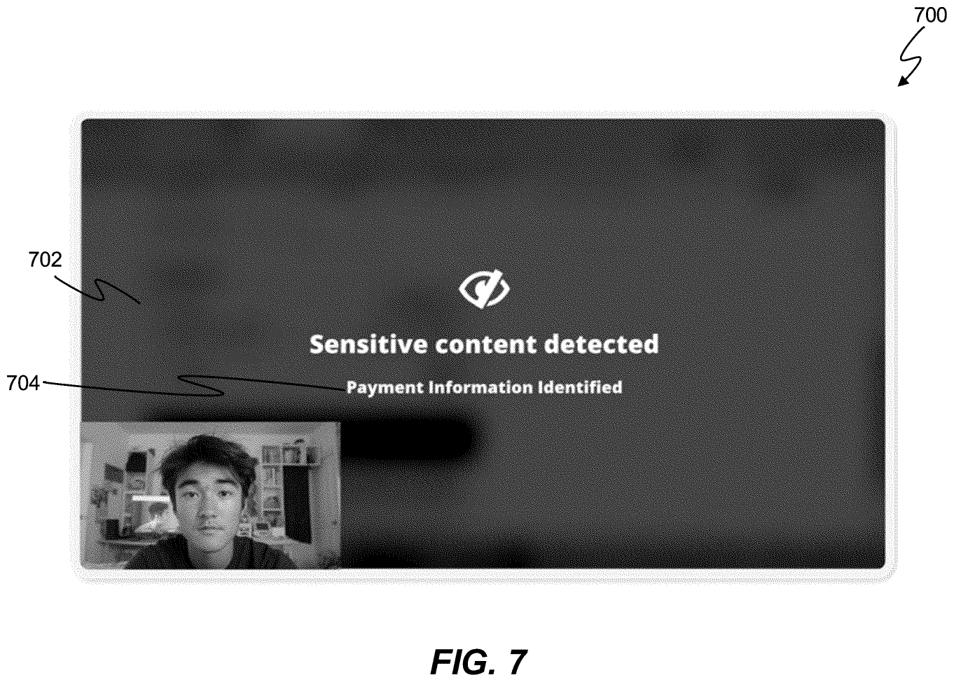

FIGS. 6-7 depict exemplary user interfaces disclosing the detection of sensitive content through blurred screens.

The user interface 600 discloses an online learning platform 602, for instance, the online learning platform 602 in the case of the present example is IXL, using which the user is undergoing some online learning session. As shown in the present example, while the user is attending the online learning session, the video extractor 112 extracts the video frames of the online learning session collected by the receiver 110. The API 114 transfers the extracted video frames to the primary AI engine 118, where the sensitive content marker 120 marks whether the content present in the received batch of video frames 116 is sensitive or not. If the sensitive content marker 120 marks the content as positive, then the positive marked sensitive content 604 is passed to the secondary AI engine 124 for further analysis and verification. If the secondary AI engine 124 also marks the content as positive then the positive marked sensitive content 604 is declared as sensitive content.

Further, the reason for the sensitivity is also listed on the user interface 600, for instance, in the case of the present example, the reason why the sensitive content marker 120 has marked the video frame as sensitive 604 is ‘Nudity Detected’ 606. Finally, the notification module 130 notifies the user about the sensitivity detection and asks the parents/guardians of the user to provide the feedback on the same using the feedback module 132.

The nudity detection 606 may occur either due to the user having opened some websites that show nude content or maybe because there are some inappropriate things captured by the video analysis module 108 from the user's webcam. For instance, in the case of the present example, the webcam of the user shows the sensitive content, hence the region where the sensitive content is marked is blurred.

The user interface 700 discloses that some sensitive information is disclosed during the online learning session which is detected by the sensitive content marker 120. For example, in the case of the present example, the user is undergoing the online learning session, and some sensitive content 702 like ‘Payment Information Detected’ 704, which may include credit/debit card details, QR code, cheque books, and other payment methods. Since the whole online learning session gets recorded and stored in the cloud database 106 for analysis, there should be some privacy maintained if such sort of sensitive information is detected. Hence, the sensitive content detection system 100 blurs the whole screen when the sensitive content 702 is detected.

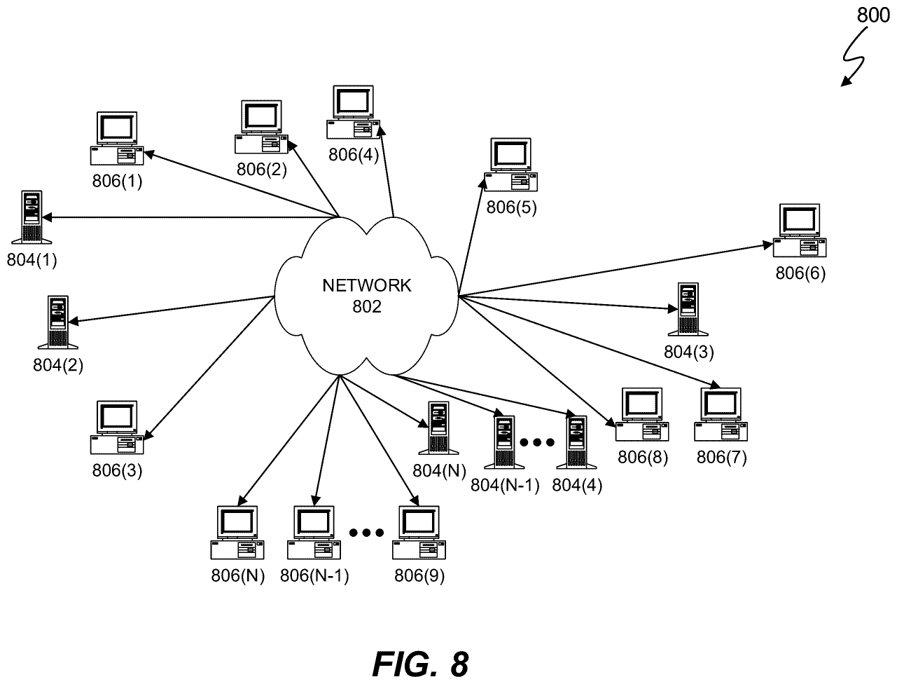

FIG. 8 is a block diagram illustrating a network environment in which the sensitive content detection system 100 and process 200 for enhancing the accuracy and reliability of the content during the online learning session in an online learning platform 102 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computers programmed to improve conventional computer systems to implement and utilize the sensitive content detection system 100 and process 200 for enhancing the accuracy and reliability of the content during the online learning session in an online learning platform 102. The type of computer system that can be specially programmed to implement and utilize the sensitive content detection system 100 and process 200 for enhancing the accuracy and reliability of the content during the online learning session in an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the sensitive content detection system 100 and process 200 for enhancing the accuracy and reliability of the content during the online learning session in an online learning platform 102 can be implemented using code stored in a tangible, non-transient computer-readable medium and executed by one or more processors. In at least one embodiment, the sensitive content detection system 100 and process 200 for enhancing the accuracy and reliability of the content during the online learning session in an online learning platform 102 can be implemented completely in hardware using, for example, logic circuits and other circuits including field programmable gate arrays.

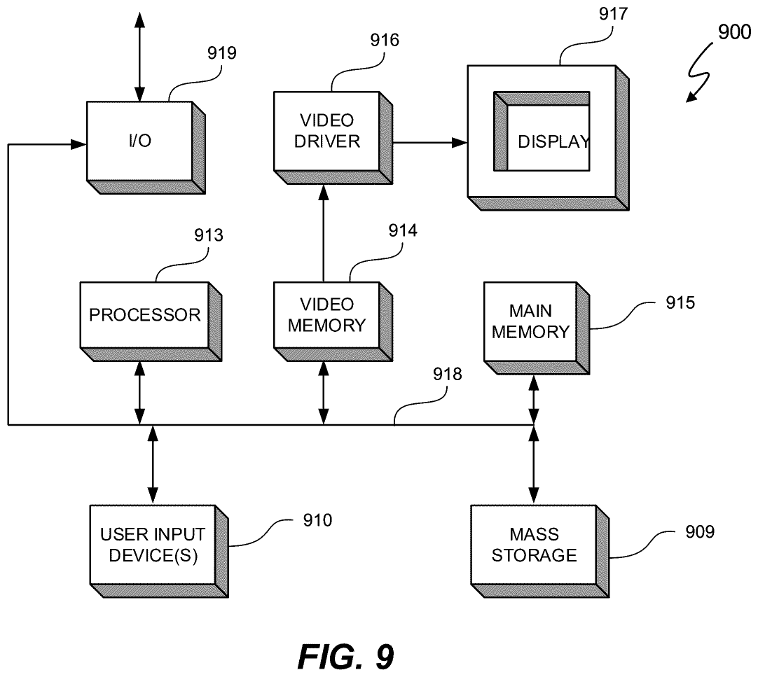

Embodiments of the sensitive content detection system 100 and process 200 for enhancing the accuracy and reliability of the content during the online learning session in an online learning platform 102 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The sensitive content detection system 100 and process 200 for enhancing the accuracy and reliability of the content during the online learning session in an online learning platform 102 may be implemented in any type of computer system or programming or processing environment. It is contemplated that the sensitive content detection system 100 and process 200 for enhancing the accuracy and reliability of the content during the online learning session in an online learning platform 102 might be run on a stand-alone computer system, such as the one described above. The sensitive content detection system 100 and process 200 for enhancing the accuracy and reliability of the content during the online learning session in an online learning platform 102 might also be run from a server computer systems system that can be accessed by a plurality of client computer systems interconnected over an intranet network. Finally, the sensitive content detection system 100 and process 200 for enhancing the accuracy and reliability of the content during the online learning session in an online learning platform 102 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of enhancing accuracy and reliability of sensitive content detection in video analysis by utilizing a plurality of AI engines, the method comprises:
executing code using one or more processors of a computer system to cause the computer system to perform operations comprising:
receiving a video data from a cloud database, wherein all the recorded videos are stored in the cloud database;
extracting video frames from the video data in pre-defined intervals, wherein each frame represents a segment of the video for analysis;
sending a batch of frames at a time to a primary AI engine that utilizes machine learning algorithms to detect sensitive content in the corresponding video frames;
marking the video frame and its corresponding frame, when a positive sensitive content is detected in any one of the video frames;
sending the marked video frames to one or more secondary AI engines, wherein each AI engine is specialized in a specific type of sensitive content detection;
aggregating the results obtained from the primary AI engine and secondary AI engines by utilizing a consensus mechanism, wherein the result is defined based on a pre-defined threshold agreement between the primary AI engine and secondary AI engines to determine a final result, whether the marked video frames includes sensitive content or not; and
presenting the final result to the user, indicating the presence or absence of the sensitive content along with a confidence score, wherein the confidence score represents the likelihood or probability that the sensitive content detected by the machine learning algorithm is correct.

2. The method of claim 1 wherein the detected sensitive content includes, nude content, payment-related information like credit card details, debit card details, and other pre-defined sensitive content types.

3. The method of claim 1 wherein the nudity-related sensitive content detection is determined based on webcam recorded data, and payment-related sensitive content detection is determined based on the screen recording.

4. The method of claim 1 wherein the primary AI engine utilizes convolutional neural networks (CNN) for analysis of the video frames and detection of the sensitive content.

5. The method of claim 1 wherein the secondary AI engines are used to cross-verify the positive marked sensitive content detected by the primary AI engine.

6. The method of claim 1 further comprises:
confirming the presence of the sensitive content, if the aggregated result is equal to or greater than the pre-defined threshold value, wherein the predefined threshold value includes 60% (⅔rd) of the agreement threshold;
confirming the absence of the sensitive content, if the aggregate result is less than the pre-defined threshold value, wherein the absence of the sensitive content at this stage is defined as false-positive.

7. The method of claim 1 further comprises:
sending the positive marked video frames for the quality check;
modifying the content in the positive marked video frames, wherein the modification is done by blurring and overlaying the corresponding positive marked video frames.

8. The method of claim 1 wherein a notification is sent to the parents of the user, including the details about the sensitive content being detected during an online learning session of the user.

9. The method of claim 1 wherein the parents can provide feedback that includes an explanation about the video frame that has been classified as sensitive content by the AI engines.

10. The method of claim 1 wherein in case of nudity-related sensitive content detection, the content of the webcam is blurred, and in case of payment-related sensitive content detection, the content of the browser is blurred.

11. The method of claim 1 wherein the modified content, including blurred and overlayed images is stored in a database.

12. The method of claim 1 wherein the output provided by the AI engines is in JSON format.

13. A system to enhance accuracy and reliability of sensitive content detection in video analysis by utilizing a plurality of AI engines, the system comprises:
one or more processors of a computer system;
a memory, coupled to the one or more processors, that stores code and execution of the code by the one or more processors causes the computer system to perform operations comprising:
receiving a video data from a cloud database by using a receiver, wherein all the recorded videos are stored in the cloud database;
extracting video frames from the video data in pre-defined intervals using a video extractor, wherein each frame represents a segment of the video for analysis;
sending a batch of frames at a time to a primary AI engine that utilizes machine learning algorithms to detect sensitive content in the corresponding video frames by utilizing an API;
marking the video frame and its corresponding frame by using a sensitive content marker, when a positive sensitive content is detected in any one of the video frames;
sending the marked video frames to one or more secondary AI engines, wherein each AI engine is specialized in a specific type of sensitive content detection;
aggregating the results obtained from the primary AI engine and secondary AI engines by utilizing an aggregator that utilizes a consensus mechanism, wherein the result is defined based on a pre-defined threshold agreement between the primary AI engine and secondary AI engines to determine a final result, whether the marked video frames includes sensitive content or not;
presenting the final result to the user via, a display module, indicating the presence or absence of the sensitive content along with a confidence score, wherein the confidence score represents the likelihood or probability that the sensitive content detected by the machine learning algorithm is correct.

14. The system of claim 13 wherein the final result is presented to the user on the same user interface in which the user is attending an online learning session.

15. The system of claim 13 wherein the primary AI engine utilizes convolutional neural networks (CNN) for analyzing the video frames and detecting the sensitive content.

16. The system of claim 13 wherein the secondary AI engines are configured to cross-verify positive sensitive content detections made by the primary AI engine.

17. The system of claim 13 further comprises:
a quality checker configured to check the quality of the positive marked sensitive content for quality verification and modifies the content in these frames by blurring and overlaying the positive marked video frames.

18. The system of claim 13 further comprises:
a notification module to notify the parents of the user, including details about the detected sensitive content during an online learning session.

19. The system of claim 13 further comprises:
a feedback module configured to allow parents to provide feedback, including explanations about the video frames classified as sensitive content by the AI engines.
